(19) United States
(12) Patent Application Publication
(10) Pub. No.: US 2024/0127983 A1
(43) Pub. Date: Apr. 18, 2024

(54) WIRE HARNESS MANUFACTURING APPARATUS AND WIRE HARNESS MANUFACTURING METHOD

(71) Applicant: YAZAKI CORPORATION, Tokyo (JP)

(72) Inventor: Masafumi Watanabe, Makinohara-shi (JP)

(21) Appl. No.: 18/464,166

(22) Filed: Sep. 8, 2023

(30) Foreign Application Priority Data
Oct. 12, 2022 (JP) 2022-164057

(51) Int. Cl. H01B 13/012

(52) U.S. Cl. CPC H01B 13/01209; H01B 13/01245

(57) ABSTRACT

A wire harness manufacturing apparatus includes: a jig plate that is used in disposing of a wire; a mobile body that retains the wire and is movable on the jig plate; and a controller configured to carry out movement control of the mobile body and cause the mobile body to move depending on a shape of a wire harness to carry out the disposing of the wire. The jig plate has a magnetic body provided in a mobile region of the mobile body, and the mobile body has a magnetic force generator that generates magnetic force that serves as attraction force with respect to the jig plate.

### CROSS-REFERENCE TO RELATED APPLICATION(S)

The present application claims priority to and incorporates by reference the entire contents of Japanese Patent Application No. 2022-164057 filed in Japan on Oct. 12, 2022.

### BACKGROUND OF THE INVENTION

### 1. Field of the Invention

The present invention relates to a wire harness manufacturing apparatus and a wire harness manufacturing method.

### 2. Description of the Related Art

Conventionally, in relation to wire harness manufacturing, for example, as described in Japanese Patent Application Laid-open No. H08-096632A, there is known a wire harness manufacturing apparatus and a wire harness manufacturing method in which a plurality of assembly jigs are attached to predetermined positions on a disposed route, and a plurality of wires are disposed along the disposed route on a wiring rack. In the wire harness manufacturing apparatus and the wire harness manufacturing method, some of the assembly jigs on the disposed route are fixed on attachable/detachable plates to form replacement jig bodies, the replacement jig bodies are formed to be attachable/detachable with respect to the wiring rack, and part of the disposed route can be changed by replacing the replacement jig bodies with other replacement jig bodies.

Meanwhile, the wire harness manufacturing apparatus and the wire harness manufacturing method described in above described Japanese Patent Application Laid-open No. H08-096632A have room for improvement in a point that manufacturing cost is high. For example, the assembly jigs are required depending on the types of products in which wire harnesses are used, and manufacturing equipment costs a lot. Moreover, since manual work by manpower is required for assembling wire harnesses, labor cost is substantial. Therefore, development of a manufacturing apparatus and a wire harness manufacturing method capable of reducing the manufacturing cost in wire harness manufacturing is desired.

### SUMMARY OF THE INVENTION

Therefore, it is an object of the present invention to provide a wire harness manufacturing apparatus and a wire harness manufacturing method capable of reducing manufacturing cost of a wire harness.

In order to achieve the above mentioned object, a wire harness manufacturing apparatus according to one aspect of the present invention includes a jig plate that is used in disposing of a wire; a mobile body that retains the wire and is movable on the jig plate; and a controller configured to carry out movement control of the mobile body and causes the mobile body to move depending on a shape of a wire harness to carry out the disposing of the wire, wherein the jig plate has a magnetic body provided in a mobile region of the mobile body, and the mobile body has a magnetic force generator that generates magnetic force that serves as attraction force with respect to the jig plate.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an outline of a configuration of a wire harness manufacturing apparatus according to a present embodiment;

FIG. 2 is an explanatory diagram of a second mobile body of the wire harness manufacturing apparatus according to the present embodiment;

FIG. 3 is an explanatory diagram of the second mobile body of the wire harness manufacturing apparatus according to the present embodiment;

FIG. 4 is an explanatory diagram of the second mobile body of the wire harness manufacturing apparatus according to the present embodiment;

FIG. 5 is an explanatory diagram of the second mobile body of the wire harness manufacturing apparatus according to the present embodiment;

FIG. 6 is a block diagram illustrating an outline of an electrical configuration of the wire harness manufacturing apparatus according to the present embodiment;

FIG. 7 is an explanatory diagram of a magnetic force generator of the wire harness manufacturing apparatus according to the present embodiment;

FIG. 8 is a flow chart of a disposing control process of a wire harness manufacturing method according to the present embodiment;

FIG. 9 is an explanatory diagram of wire disposing of the wire harness manufacturing method according to the present embodiment;

FIG. 10 is an explanatory diagram of attachment of an exterior part or the like using the wire harness manufacturing apparatus according to the present embodiment; and

FIG. 11 is an explanatory diagram of attachment of an exterior part or the like using the wire harness manufacturing apparatus according to the present embodiment.

### DETAILED DESCRIPTION OF THE PREFERRED EMBODIMENTS

Hereinafter, an embodiment according to the present invention will be described in detail based on drawings. Note that the invention is not limited by this embodiment. The constituent elements of the embodiment described below include the elements replaceable and easily replaceable by those skilled in the art or include practically the same elements.

### Embodiment

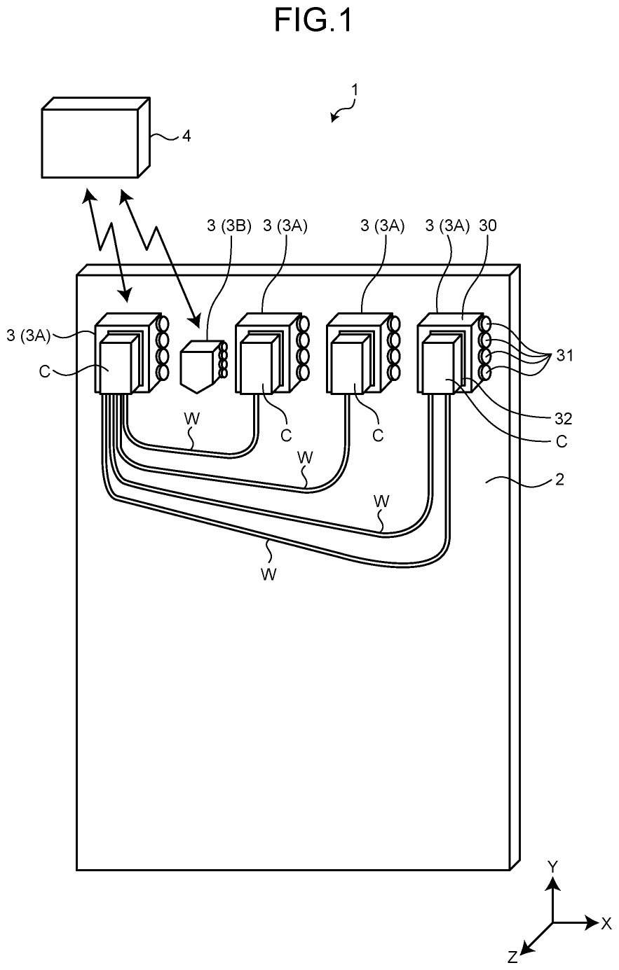

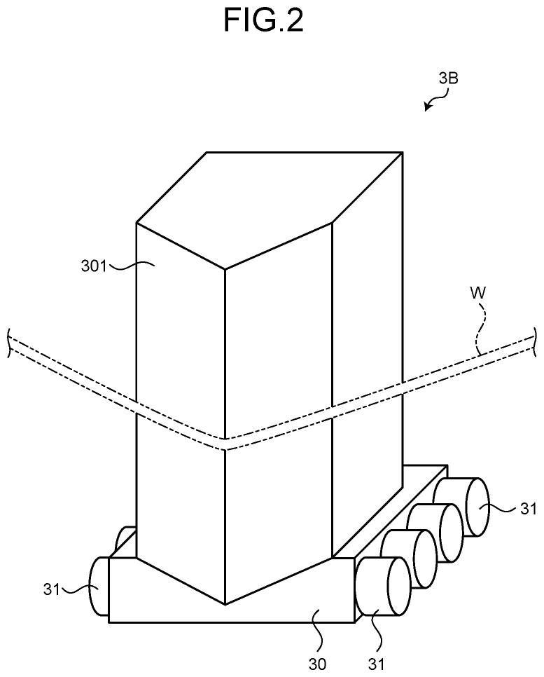

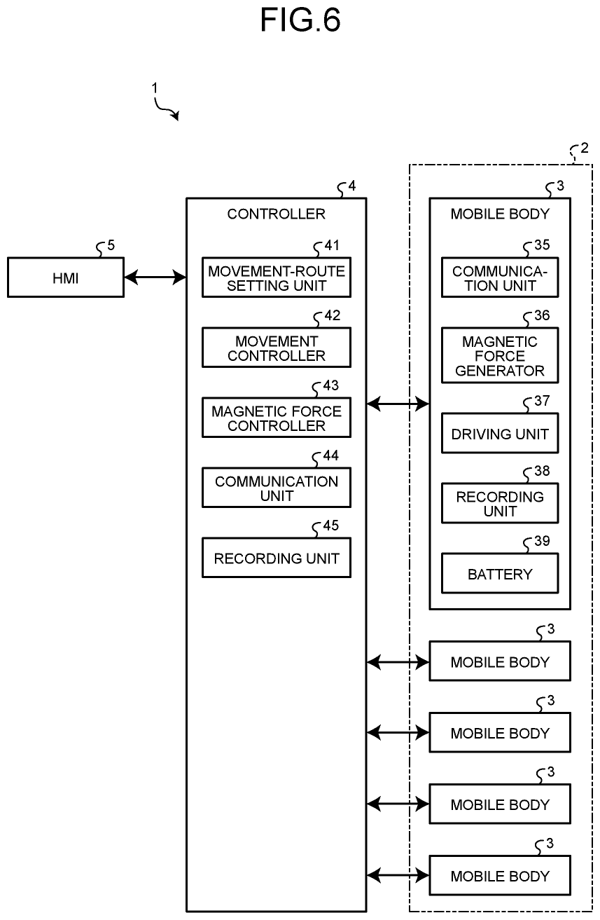

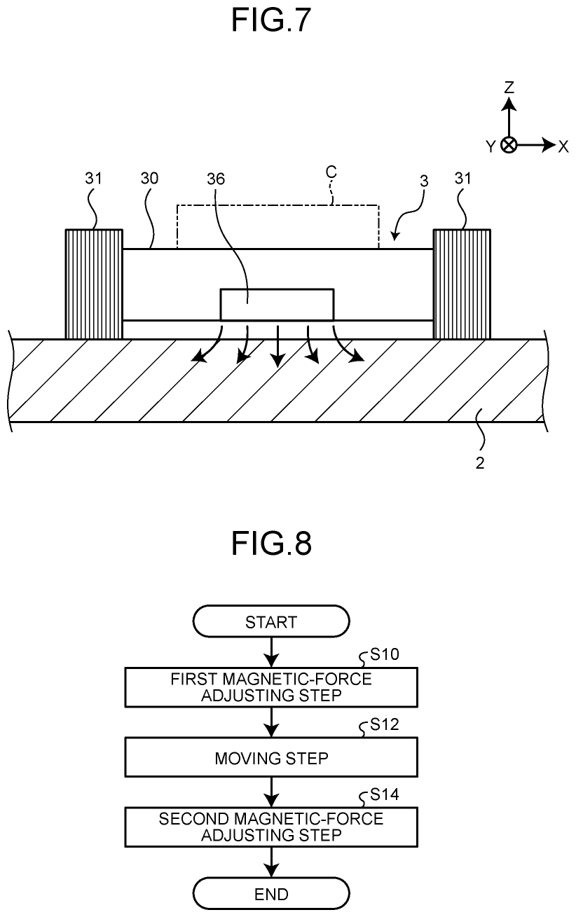

FIG. 1 is a diagram illustrating an outline of a configuration of a wire harness manufacturing apparatus according to the present embodiment, and FIGS. 2 to 5 are explanatory diagrams of a second mobile body of the wire harness manufacturing apparatus according to the present embodiment. FIG. 6 is a block diagram illustrating an outline of an electrical configuration of the wire harness manufacturing apparatus according to the present embodiment, and FIG. 7 is an explanatory diagram of a magnetic force generator of the wire harness manufacturing apparatus according to the present embodiment.

A wire harness manufacturing apparatus 1 according to the present embodiment illustrated in FIG. 1 is an apparatus for manufacturing a wire harness WH, and wires or disposes a wire W depending on the shape of the wire harness WH. The wire harness WH according to the present embodiment is, for example, an assembly part which is a bundle of a plurality of wires W, which are used for power supply or signal communication for connection between equipment mounted on a vehicle, and connects the plurality of wires W to the equipment by connectors, etc. The wire harness WH of the present embodiment is provided with the wires W having electrical conductivity, the connectors C, and an exterior material T. The wire W is, for example, an insulating wire having a core wire, which is a plurality of bundled metal element wires having electrical conductivity, covered with insulating coating. The wire W may be a bundle of a plurality of insulating wires. The connector C is provided at a terminal of the wires W, forms a part electrically connected with a connection counterpart by mating the connector with the connection counterpart (typically, another connector C), and connects the wire W with the connection counterpart so as to establish conduction therebetween. The exterior material T is a protective member which has interior in which the wires W are inserted and disposed, serves as exterior of the wires W, protects the wires W disposed in the interior thereof, and restricts a disposed route. The exterior material T is, for example, a corrugated tube formed in a tubular shape using a resin material having insulating properties, a protector, a metal pipe formed in a tubular shape using a metal material having electrical conductivity, or the like. In addition, the wire harness WH may be configured to further include various constituent parts such as a grommet, an electrical junction box, a fixture, and a connector.

As illustrated in FIG. 1, the wire harness manufacturing apparatus 1 is provided with a jig plate 2, mobile bodies 3, and a controller 4. The jig plate 2 is a plate body used for manufacturing the wire harness WH and uses a plate body larger than the wire harness WH to be manufactured. For example, during manufacturing of the wire harness, the jig plate 2 is perpendicularly or obliquely installed. The jig plate 2 is used to dispose the wires W of the wire harness WH. Also, the jig plate 2 may be used for attaching the exterior material T, conduction checking of the wire harness WH, etc. other than disposing of the wires W.

The jig plate 2 has a magnetic body provided in a mobile region of the mobile bodies 3. The mobile region of the mobile bodies 3 is a region on the jig plate 2 in which the mobile bodies 3 move for disposing the wires W and is, for example, a disposed region of the wires W. For example, the jig plate 2 uses a plate body made of iron, and the entire jig plate 2 is the magnetic body. Also, the jig plate 2 may be built by an object which is a magnetic body other than iron or may be a laminated plate body including layers of objects which are magnetic bodies.

On the jig plate 2, the plurality of mobile bodies 3 are placed. The mobile bodies 3 are the carts which retain the wires W and are movable on the jig plate 2. The mobile bodies 3 carry out disposing or wiring of the wires W depending on the shape of the wire harness WH by moving on the jig plate 2 in the state in which the wires W are retained. Therefore, the wire harness manufacturing apparatus 1 can automatically dispose the wires W by the mobile bodies 3 and can significantly reduce manual work of workers.

The plurality of mobile bodies 3 include first mobile bodies 3A connected to the wires W and a second mobile body 3B not connected to the wire W. The first mobile bodies 3A and the second mobile body 3B are provided with wheels 31 on the left and right of main bodies 30 thereof, can be self-propelled, and have a common basic configuration as mobile objects. The first mobile bodies 3A are connected to the wires W and retain the wires W. For example, the first mobile body 3A is connected to an end of the wire W via the connector C. Therefore, the first mobile body 3A can move the end of the wire W by moving. Note that, herein, a case in which the first mobile bodies 3A are connected to the wires W indirectly via the connectors C is shown, but the first mobile bodies 3A may be directly connected to the wires W. The second mobile body 3B is not connected to the wire W, but, during the disposing, contacts the wire W, which is connected to the first mobile body 3A, and pushes the wire W thereagainst to retain the wire. During the disposing, the second mobile body 3B is actuated to build the disposed shape or wiring shape of the wire W connected to the first mobile body 3A. In other words, the second mobile body 3B is a mobile body for branch forming of the wire harness WH.

As illustrated in FIG. 2, the second mobile body 3B for branch forming forms, for example, a pusher 301 in an upper portion of the main body 30. The pusher 301 is a member for pushing the wire W, which is retained by the other mobile body 3, to form a branch shape. The pusher 301 has a shape tapered with respect to a traveling direction and is built, for example, by a block member having a pentagonal shape as a horizontal cross section.

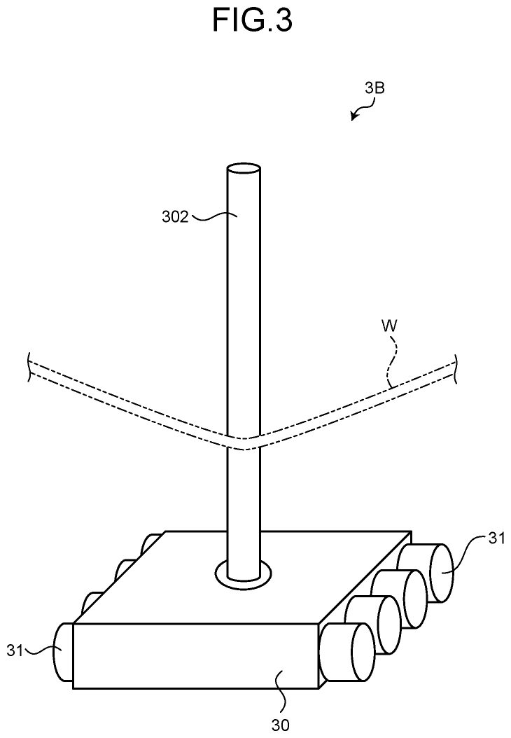

Also, as illustrated in FIG. 3, the second mobile body 3B for branch forming may have a structure in which a rod member 302 is set up on an upper portion of the main body 30. Also in this case, the second mobile body 3B can push the wire W, which is retained by the other mobile body 3, and form a branch shape.

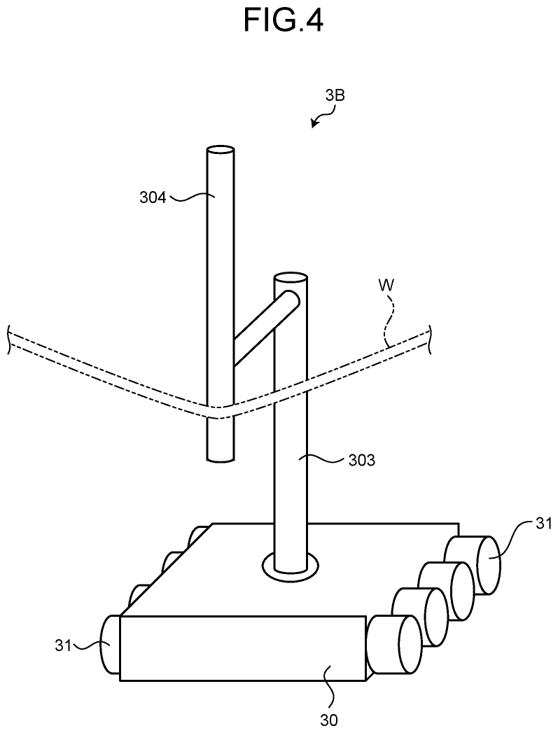

Also, as illustrated in FIG. 4, the second mobile body 3B for branch forming may have a structure in which a pillar 303 is set up on an upper portion of the main body 30, and a perpendicularly extending rod member 304 is attached at a position in front of the pillar 303. Also in this case, the second mobile body 3B for branch forming can push the wire W, which is retained by the other mobile body 3, and form a branch shape.

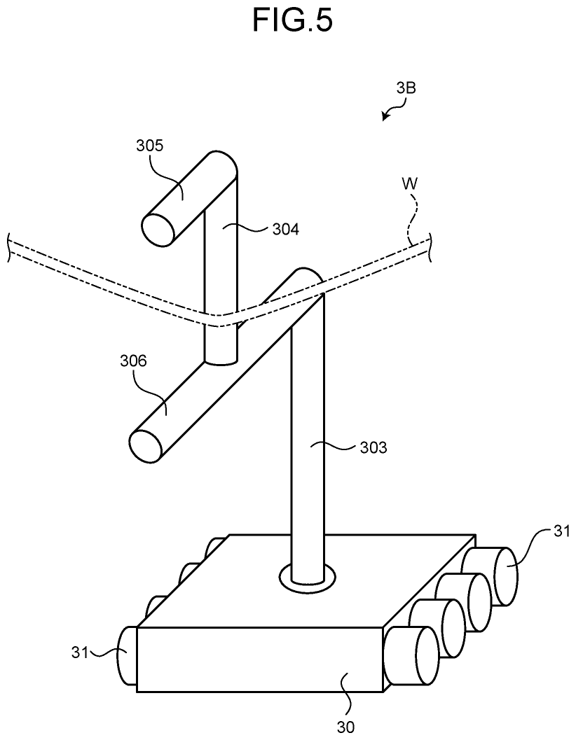

Furthermore, as illustrated in FIG. 5, the second mobile body 3B for branch forming may have a structure in which the pillar 303 is set up on an upper portion of the main body 30, a perpendicularly extending rod member 304 is attached at a position in front of the pillar 303, and horizontal rod members 305, 306 extending forward are provided at an upper portion and a lower portion of the rod member 304. Also in this case, the second mobile body 3B for branch forming can push the wire W, which is retained by the other mobile body 3, and form a branch shape. Moreover, the second mobile body 3B for branch forming can restrain the pushed wire W from being detached from the rod member 304 by the horizontal rod members 305, 306.

Note that FIG. 1 illustrates the case in which the five mobile bodies 3 are used. However, three, four, six, or more mobile bodies 3 may be used. Also, FIG. 1 illustrates the case in which the single second mobile body 3B for branch forming is used. However, two or more second mobile bodies 3B for branch forming may be used. Also, FIG. 1 illustrates the case in which the first mobile bodies 3A and the second mobile body 3B are used. However, an assembly jig having a U-shape, a fork shape, or the like may be used instead of the second mobile body 3B for branch forming, and only the first mobile bodies 3A may be used as the mobile bodies 3. More specifically, the assembly jig may be placed at a preset position on the jig plate 2, and the first mobile body 3A to which the wire W is connected may move to carry out disposing of the wire W.

In FIG. 1, the mobile bodies 3 (the first mobile bodies 3A, the second mobile body 3B) can be self-propelled, for example, have the wheels 31, and move on the jig plate 2 by rotating the wheels 31. More specifically, the mobile body 3 causes the wheels 31 to contact a surface of the jig plate 2 and moves on the jig plate 2 by rotating the wheels 31. The plurality of wheels 31 is provided on the left and the right of the main body 30 of the mobile body 3. For example, the mobile body 3 can move forward when the left and right wheels 31 rotate forward, move backward when the left and right wheels 31 rotate reversely, and move to turn when the left and right wheels 31 rotate at different rotating speeds. Note that, in FIG. 1, the wheels 31 of the mobile body 3 are provided so that the four wheels are on both the left and right. However, the wheels 31 of the mobile body 3 may be provided so that two, three, five, or more wheels are on both of the left and right. Also, in FIG. 1, the circular wheels 31 are used as traveling units of the mobile bodies 3. However, a continuous track (crawler), in which a plurality of wheels are surrounded by shoes, may be used.

The first mobile body 3A has a retainer 32, which retains the wire W. For example, as the retainer 32, a connector is used. In such a case, the retainer 32 is connected to the connector C, which is attached to the end of the wire W, and functions as a counterpart connector. When the retainer 32 and the connector C are connected to each other, the wire W is connected to the first mobile body 3A and retained.

As illustrated in FIG. 6, the mobile body 3 has a communication unit 35, a magnetic force generator 36, a driving unit 37, a recording unit 38, and a battery 39. The communication unit 35, the magnetic force generator 36, the driving unit 37, the recording unit 38, and the battery 39 are, for example, built in the main body 30. The communication unit 35 is a transceiver for carrying out wireless communication with the controller 4. The mobile body 3 receives control signals from the controller 4 via the communication unit 35.

As illustrated in FIG. 7, the magnetic force generator 36 is a part which generates magnetic force, which works as attraction force with respect to the jig plate 2, and, for example, includes an electromagnet. The magnetic force generator 36 is provided in the main body 30 and is placed at a position adjacent to the jig plate 2. The magnetic force generator 36 can adjust the intensity of generated magnetic force and weakens the magnetic force when the mobile body 3 is moving compared with the magnetic force while the mobile body 3 still. By virtue of this, the magnetic force generator 36 can firmly fix the mobile body 3 to the jig plate 2 while the mobile body 3 is still and can smoothly move the mobile body 3 by weakening the magnetic force while the mobile body 3 is moving.

In FIG. 6, the driving unit 37 is a part which applies drive force to the wheels 31 and, for example, includes a drive source such as a motor and a drive circuit for driving the drive source. The driving unit 37 drives in accordance with the control signals from the controller 4 and actuates the wheels 31. The recording unit 38 records movement control data, magnetic-force control data, etc. of the mobile body 3. The battery 39 is an electric-power supply source for equipment such as the magnetic force generator 36 and the driving unit 37 provided in the mobile body 3. As the battery 39, for example, a rechargeable secondary battery is used.

The controller 4 is a control unit which carries out overall control of the wire harness manufacturing apparatus 1, for example, carries out movement control of the mobile bodies 3, and moves the mobile bodies 3 depending on the shape of the wire harness WH to carry out disposing of the wires W. The controller 4, for example, for example, includes a computer having a processor such as a Central Processing Unit [CPU], memories such as a Read Only Memory [ROM] and a Random Access Memory [RAM].

The controller 4 is provided with a movement-route setting unit 41, a movement controller 42, a magnetic force controller 43, a communication unit 44, and a recording unit 45. The movement-route setting unit 41, the movement controller 42, and the magnetic force controller 43 are built, for example, by introducing programs which execute the corresponding functions to the controller 4. Also, the movement-route setting unit 41, the movement controller 42, and the magnetic force controller 43 may be individually installed in the controller 4 as control units which execute the corresponding functions.

The movement-route setting unit 41 sets movement routes of the mobile bodies 3 on the jig plate 2. For example, the movement-route setting unit 41 sets coordinates corresponding to the surface of the jig plate 2 and sets coordinate values of movement start positions and movement end positions of the mobile bodies 3 depending on the shape of the wire harness WH. In a case in which the mobile body 3 is placed at a start position determined in advance, the coordinate values of the movement start position of the mobile body 3 are the coordinate values of the start position. The coordinate values of the movement end position of the mobile body 3 are set depending on the shape of the wire harness WH. Then, the movement-route setting unit 41 generates a route connecting the movement start position and the movement end position of the mobile body 3 as a movement route. Herein, it is desired that the movement routes of the plurality of mobile bodies 3 do not mutually intersect. However, even in a case in which the movement routes mutually intersect, the mobile bodies 3 can be smoothly moved by mutually shifting movement timing. In such a case, in setting of the movement routes, the setting may be carried out in consideration of the moving speeds of the mobile bodies 3. More specifically, the movement routes may be set by associating the movement positions and the moving speeds of the movement routes of the mobile bodies 3.

The movement controller 42 outputs the control signals about movement to the mobile bodies 3. For example, the movement control signals output the control signals which actuate the driving unit 37 so as to move the mobile bodies 3 along the movement routes. As a result, the driving unit 37 actuates, the wheels 31 rotate, and the mobile bodies 3 move along the set movement routes.

The magnetic force controller 43 controls the actuation of the magnetic force generator 36. For example, the magnetic force controller 43 outputs the control signals to the magnetic force generator 36 and actuates the magnetic force generator 36 to generate strong magnetic force from the magnetic force generator 36 while the mobile body 3 is still and generate magnetic force, which is weaker than that of the case in which the mobile body 3 is still, while the mobile body 3 is moving.

The communication unit 44 communicates with the mobile bodies 3. The communication unit 44 carries out wireless communication with the mobile bodies 3 and transmits/receives signals to/from the communication units 35 of the mobile bodies 3. The recording unit 45 records movement route data, magnetic-force control data, etc. of the mobile bodies 3.

A Human Machine Interface [HMI] 5 is connected to the controller 4. The HMI 5 is, for example, an operating device for the controller 4 and functions as an input device and an output device. The HMI 5 corresponds to, for example, switches, input buttons, a keyboard, speakers, and a display motor.

Next, operation of the wire harness manufacturing apparatus and a wire harness manufacturing method according to the present embodiment will be described.

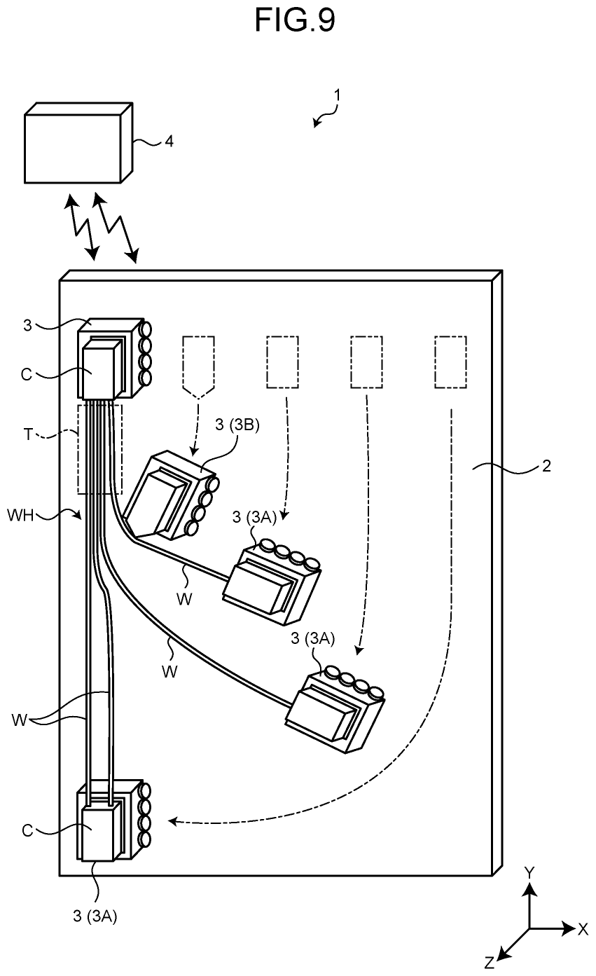

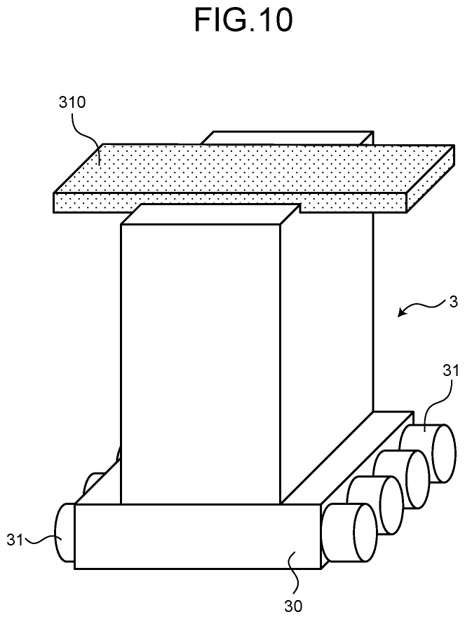

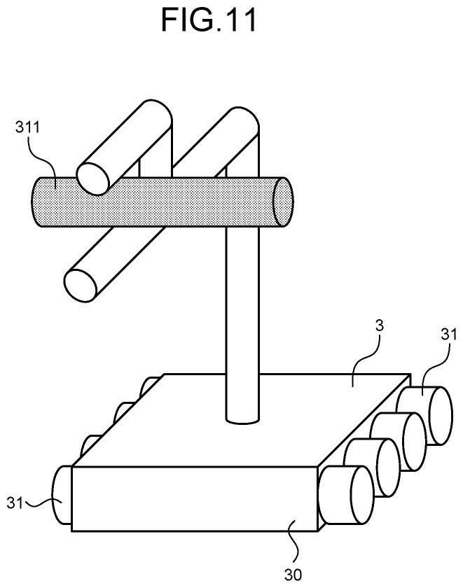

FIG. 8 is a flow chart of a disposing control process of the wire harness manufacturing method. FIG. 9 is an explanatory diagram of wire disposing in the wire harness manufacturing method. FIG. 10 and FIG. 11 are explanatory diagrams of attaching exterior parts, etc. in wire harness manufacturing.

As illustrated in FIG. 1, the wires W are connected, and initial positions of the mobile bodies 3 are set. The mobile bodies 3 are installed at the initial positions on the jig plate 2. For example, the mobile bodies 3 are placed to be juxtaposed at the positions on an upper portion of the jig plate 2. Herein, since the initial positions of the mobile bodies 3 are the positions on the upper portion of the jig plate 2, the mobile bodies 3 move from above to below. Therefore, upward movement of the mobile bodies 3 can be avoided, and consumption of the batteries 39 of the mobile bodies 3 can be suppressed.

As the initial positions of the mobile bodies 3, for example, the first mobile body 3A, the second mobile body 3B, the first mobile body 3A, the first mobile body 3A, and the first mobile body 3A are placed in this order from the left. For example, the four wires W are connected to the leftmost first mobile body 3A. In FIG. 1, the single connector C is connected to the leftmost first mobile body 3A. However, four connectors C may be connected to correspond to the four wires W. The two wires W among the four wires W connected to the leftmost first mobile body 3A are connected to the rightmost (the fifth from the left) first mobile body 3A. Also, the wire W which is one of the four wires W connected to the leftmost first mobile body 3A is connected to the first mobile body 3A which is the third from the left. Furthermore, the wire W which is one of the four wires W connected to the leftmost first mobile body 3A is connected to the first mobile body 3A which is the fourth from the left. The wires W are not connected to the second mobile body 3B which is the second from the left. As the wires W connected to the mobile bodies 3, the wires having the lengths corresponding to the shape of the wire harness WH are used.

In the state in which the mobile bodies 3 (the first mobile bodies 3A, the second mobile body 3B) are set at the initial positions, the magnetic force generator 36 of the mobile bodies 3 are actuated, and the mobile bodies 3 are attracted to the jig plate 2 by the magnetic force. Therefore, the mobile bodies 3 can maintain the positions without slipping off from the jig plate 2, which is perpendicular or tilted. The wire W is connected by connecting the connector C, which is attached to the end of the wire W, to the retainer 32 of the mobile body 3. As a result, the end of the wire W is retained by any of the mobile bodies 3.

Then, the wires W are disposed. The disposing of the wires W is carried out by disposing control using movement of the mobile bodies 3. The disposing control process of FIG. 8 is, for example, started by start operation of the HMI 5 and executed by the controller 4. As the disposing control process, first, as illustrated in Step S10 (Hereinafter, it will be simply referred to as “S10”. The same applies also to following steps S) of FIG. 8, a first magnetic-force adjusting step is carried out. The first magnetic-force adjusting step is a step in which the intensity of the magnetic force generated by the magnetic force generator 36 is adjusted, and the magnetic force is caused to be weaker than the magnetic force of the still case in preparation for movement of the mobile bodies 3. More specifically, the control signals are output from the magnetic force controller 43 of the controller 4 to the mobile bodies 3, and the generated magnetic force of the magnetic force generator 36 is weakened. As a result, the mobile bodies 3 are attracted to the jig plate 2, but can easily move because of reduction in the magnetic force.

Then, the process transitions to S12, and a moving step is carried out. The moving step is a step in which the mobile bodies 3 are moved depending on the shape of the wire harness WH. More specifically, the control signals are output from the movement controller 42 of the controller 4 to the mobile bodies 3, and the driving unit 37 is actuated. As a result, the wheels 31 of the mobile bodies 3 rotate, and the mobile bodies 3 move on the jig plate 2. The movement routes of the mobile bodies 3 are the routes set in advance depending on the shape of the wire harness WH. Regarding movement of the mobile bodies 3, all of the mobile bodies 3 may be moved all at once, the mobile bodies 3 may be moved individually in order, or the mobile body (ies) 3 may appropriately move in advance while the other mobile bodies 3 move simultaneously. As a result of this moving step, as illustrated in FIG. 9, the wires W are disposed in the shape corresponding to the wire harness WH. More specifically, the first mobile bodies 3A move to the positions of the ends of the wires W of the wire harness WH. The second mobile body 3B abuts the wire W, which is connected to the first mobile body 3A, pushes the wire W, and moves. As a result, branch shapes are formed at the plurality of wires W.

Then, after the moving step of S12 is finished, a second magnetic-force adjusting step is carried out (S14). The second magnetic-force adjusting step is a step in which the intensity of the magnetic force generated by the magnetic force generator 36 is adjusted, and the magnetic force is caused to be stronger than the magnetic force of the case in which the mobile bodies 3 are moving. More specifically, the control signals are output from the magnetic force controller 43 of the controller 4 to the mobile body 3, and the generated magnetic force of the magnetic force generator 36 is intensified compared with the magnetic force of the first magnetic-force adjusting step. As a result, the mobile bodies 3 are strongly attracted to the jig plate 2, and the mobile bodies 3 are fixed to still positions. Therefore, in this state, attachment of the exterior material T, conduction checking, etc. can be smoothly carried out. When the second magnetic-force adjusting step of S14 is finished, the series of disposing control process of FIG. 8 is finished.

By the disposing control process, the wires W can be disposed by moving the mobile bodies 3 depending on the shape of the wire harness WH. Therefore, jigs corresponding to the types of the wire harnesses WH are not required, and the equipment investment for wire harness manufacturing can be significantly reduced. Also, installation of jigs for each type of the wire harness WH is not required, and manufacturing areas can be significantly reduced. Also, since the wires W can be disposed by moving the mobile bodies 3, manual work of workers can be significantly reduced. In this manner, the manufacturing cost of the wire harness WH can be reduced. Also, since the mobile bodies 3 can be attracted to the jig plate 2 by the magnetic force, even if the jig plate 2 is tilted or perpendicular, the mobile bodies 3 can be moved, and the wire harness WH can be manufactured.

Then, as illustrated in FIG. 9, in the state in which the wires W are disposed, the exterior material T, etc. are attached to the wires W. For example, the wires W are bundled, and a corrugated tube, tape, or the like is attached thereto as the exterior material T. In this process, since the mobile bodies 3 are firmly retained with respect to the jig plate 2, the exterior material T can be smoothly attached. Also, in this process, the exterior material T can be carried by the mobile body 3. For example, as illustrated in FIG. 10, an attachment part 310 may be mounted on the mobile body 3 and moved to a work position. Examples of the attachment part 310 include a clamp, a protector, a cover, etc. As a result, the attachment part 310 can be efficiently attached by using the wire harness manufacturing apparatus 1. Also, as illustrated in FIG. 11, a protective part 311 may be mounted on the mobile body 3 and moved to a work position. Examples of the protective part 311 include a corrugated tube, tape, etc. As a result, the protective part 311 can be efficiently attached by using the wire harness manufacturing apparatus 1.

Then, the exterior material T, etc. are attached to the wires W, and the wire harness WH is manufactured. Thereafter, the wire harness WH may be subjected to conduction checking by using the jig plate 2. Note that the conduction checking may be carried out by using a jig dedicated for conduction checking. However, since the wires W are electrically connected to the mobile bodies 3 via the connectors C, the conduction checking can be carried out by using the wire harness manufacturing apparatus 1. For example, check signals are output from the controller 4 to the mobile body 3, and the conduction checking of the wire harness WH can be carried out by checking whether the check signals can be received through the other mobile bodies 3 connected by the wires W. When this conduction checking is finished, manufacturing of the wire harness WH is finished.

As described above, according to the wire harness manufacturing apparatus 1 according to the present embodiment, the mobile bodies 3 can be moved depending on the shape of the wire harness WH to dispose the wires W, and the wire harness WH can be manufactured. Therefore, jigs corresponding to the types of the wire harnesses WH are not required, and the equipment investment for wire harness manufacturing can be significantly reduced. Also, installation of jigs for each type of the wire harness WH is not required, and manufacturing areas can be significantly reduced. Also, since the wires W can be disposed by moving the mobile bodies 3, manual work of workers can be significantly reduced. Therefore, the manufacturing cost of the wire harness WH can be reduced. Also, since the mobile bodies 3 can be attracted to the jig plate 2 by the magnetic force, even if the jig plate 2 is tilted or perpendicular, the mobile bodies 3 can be moved, and the wire harness WH can be smoothly manufactured.

Also, the wire harness manufacturing apparatus 1 according to the present embodiment weakens the magnetic force by the magnetic force generator 36 of the mobile bodies 3 when the mobile bodies 3 are moving compared with the magnetic force of the case in which the mobile bodies 3 are still. Therefore, the wire harness manufacturing apparatus 1 according to the present embodiment can smoothly move the mobile bodies 3 on the jig plate 2 and efficiently manufacture the wire harness WH.

The wire harness manufacturing apparatus 1 according to the present embodiment includes, as the mobile bodies 3, the first mobile bodies 3A connected to the wires W and the second mobile body 3B not connected to the wires W. By using the second mobile body 3B not connected to the wires W, the plurality of wires W can be branched to form the wire harness WH. Therefore, the wire harness manufacturing apparatus 1 according to the present embodiment can efficiently manufacture the wire harness WH.

According to the wire harness manufacturing method according to the present embodiment, since the mobile bodies 3 are attracted to the jig plate 2 by the magnetic force, the mobile bodies 3 can maintain the positions thereof and move to desired positions without slipping off from the jig plate 2, which is perpendicular or tilted. Then, when the mobile bodies 3 move depending on the shape of the wire harness WH, the wires W can be disposed, and the wire harness WH can be manufactured. Therefore, jigs corresponding to the types of the wire harnesses WH are not required, and the equipment investment for wire harness manufacturing can be significantly reduced. Also, installation of jigs for each type of the wire harness WH is not required, and manufacturing areas can be significantly reduced. Also, since the wires W can be disposed by moving the mobile bodies 3, manual work of workers can be significantly reduced. Therefore, the wire harness manufacturing method according to the present embodiment can reduce the manufacturing cost of the wire harness WH.

Also, in the wire harness manufacturing method according to the present embodiment, since the magnetic force generated by the magnetic force generator 36 is intensified after the disposing of the wires W in the moving step is finished, the still mobile bodies 3 can be fixed on the jig plate 2. Therefore, the wire harness manufacturing method according to the present embodiment can smoothly carry out attachment of the exterior material T or conduction checking with respect to the disposed wires W.

Note that the wire harness manufacturing apparatus and the wire harness manufacturing method according to the above described embodiment of the present invention are not limited to the above described embodiment, and various modifications can be made within the scope described in claims.

For example, in the above described embodiment, the manufacturing apparatus and the manufacturing method of the wire harness WH used in a vehicle have been described. However, the present invention may be applied to a manufacturing apparatus and a manufacturing method of the wire harness WH used in equipment other than vehicles.

Also, in the above described embodiment, the mobile bodies 3 and the controller 4 carry out wireless communication, but the mobile bodies 3 and the controller 4 may carry out wired communication. For example, the mobile bodies 3 and the controller 4 may be electrically connected by cables or the like to transmit/receive signals. Also in such a case, as well as the above described embodiment, the manufacturing cost of the wire harness WH can be reduced. Also, in such a case, mounting of the batteries 39 on the mobile bodies 3 can be omitted.

The wire harness manufacturing apparatus and the wire harness manufacturing method according to the present embodiment can reduce manufacturing cost of a wire harness.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness manufacturing apparatus comprising:
a jig plate that is used in disposing of a wire;
a mobile body that retains the wire and is movable on the jig plate; and
a controller configured to carry out movement control of the mobile body and causes the mobile body to move depending on a shape of a wire harness to carry out the disposing of the wire, wherein
the jig plate has a magnetic body provided in a mobile region of the mobile body, and
the mobile body has a magnetic force generator that generates magnetic force that serves as attraction force with respect to the jig plate.

2. The wire harness manufacturing apparatus according to claim 1, wherein
the magnetic force generator enables adjustment of intensity of the magnetic force and weakens the magnetic force while the mobile body is moving compared with the magnetic force while the mobile body is still.

3. The wire harness manufacturing apparatus according to claim 1, wherein
the mobile body includes a first mobile body connected to the wire and a second mobile body not connected to the wire,
the first mobile body is connected to the wire and retains the wire, and
the second mobile body contacts, during the disposing, the wire connected to the first mobile body to retain the wire connected to the first mobile body.

4. The wire harness manufacturing apparatus according to claim 2, wherein
the mobile body includes a first mobile body connected to the wire and a second mobile body not connected to the wire,
the first mobile body is connected to the wire and retains the wire, and
the second mobile body contacts, during the disposing, the wire connected to the first mobile body to retain the wire connected to the first mobile body.

5. A wire harness manufacturing method comprising:
a first magnetic-force adjusting step of placing, on a jig plate having a magnetic body, a mobile body that retains a wire to be disposed and has a magnetic force generator, and attracting the mobile body to the jig plate by magnetic force of the magnetic force generator; and
a moving step of moving the mobile body depending on a shape of a wire harness to dispose the wire.

6. The wire harness manufacturing method according to claim 5, further comprising:
a second magnetic-force adjusting step of, after the disposing of the wire in the moving step is finished, intensifying the magnetic force generated by the magnetic force generator compared with the magnetic force in the first magnetic-force adjusting step to fix the still mobile body onto the jig plate.
